(19) United States
(12) Patent Application Publication
(10) Pub. No.: US 2006/0056798 A1
(43) Pub. Date: Mar. 16, 2006

(54) AV signal switching apparatus and method in multifunction device

(75) Inventor: Jong Hyun Yoon, Seoul (KR)

Correspondence Address: JOKATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/226,996

(22) Filed: Sep. 14, 2005

(30) Foreign Application Priority Data
Sep. 16, 2004 (KR) 2004-0074100

(51) Int. Cl. H04N 5/91; H04N 5/268

(52) U.S. Cl. 386/46; 348/706

(57) ABSTRACT

An AV signal switching apparatus in a multifunction device separates the operation control of an AV reproduction device and a TV set for a further smooth control thereof such that static is not created by setting a mute time if the AV signal is switched. According to the present invention, an AV reproduction device, a TV set and an interface unit are integrally disposed. The AV reproduction device and the TV set are respectively equipped with a first and a second controller such that the first and the second controller respectively control the operation of the AV reproduction device and the TV set. Furthermore, the switching is conducted with a predetermined period of mute time being set if an AV signal processor switches and selects a reproduction AV signal reproduced by the AV reproduction device from a storing medium and an AV signal of TV broadcasting signal received by a tuner of the TV set.

### CROSS REFERENCE TO RELATED APPLICATIONS

Pursuant to 35 U.S.C. § 119(a), this application claims the benefit of earlier filing date and right of priority to Korean Patent Application No. 10-2004-0074100, filed on Sep. 16, 2004, the content of which is hereby incorporated by reference herein in its entirety.

### BACKGROUND OF THE INVENTION

1. Field of the Invention

The present invention relates to a multifunction device integrally formed in one set with Audio Video (AV) playback systems such as a Video Cassette tape Recorder (VCR) and a Digital Versatile Disc (DVD) player and a television (TV) set. More particularly, the present invention relates to an AV signal switching apparatus and method in a multifunction device wherein an AV signal reproduced from a predetermined storage medium and an AV signal of a TV broadcasting signal of a predetermined channel received by a TV set are switched in a multifunction device.

2. Description of the Related Art

A storage medium for storing an AV signal includes a videocassette tape and a DVD. Various AV playback (hereinafter referred to as reproduction) apparatuses including the VCR and DVD for reproducing an AV signal stored in the storage medium are widely distributed.

In order to listen to the AV signal reproduced by the AV reproduction apparatuses, image display devices such as a monitor, a TV set and the like are needed. A great amount of equipment costs incurs if an AV reproduction apparatus and an image display device are separately purchased.

A multifunction device integrally equipped with an AV reproduction apparatus and an image display device has been developed and widely distributed. The multifunction device thus explained is configured in such a manner that an AV signal reproduced by an AV reproduction apparatus via a storage medium and an AV signal of a TV broadcasting signal received by a TV set can be selectively switched and listened to.

A singular controller is equipped at a conventional multifunction device in order to switch the signals, and the controller is configured to control all the operations of the AV reproduction apparatus and the TV set. A cost burden incurs if an excellent Central Processing Unit (CPU) is used via a singular controller. As a measure to cost down the equipment costs, a low performance of CPU via a singular controller is used. With the use of a CPU of low performance, a manufacturing cost of products can be achieved.

However, there is a problem in that a singular controller can be burdened with an overload if the controller controls all the operations of the AV reproduction apparatus and the TV set. There is another problem in that the operation control of the AV reproduction apparatus and the TV set and a switching operation of the AV signal cannot be smoothly implemented due to the overload thus generated.

FIG. 1 is a block diagram illustrating a configuration of a multifunction device integrally formed with a TV set and an AV reproduction apparatus according to the prior art, where reference numeral 100 is a controller. The controller (100) serves to control reception of a TV broadcasting signal, a reproduction operation of a reproduction medium and a switching operation of the received AV signal of the TV broadcasting signal and an AV signal reproduced from a reproduction medium.

Reference numeral 110 is an instruction input unit. The instruction input unit (110) is disposed with a plurality of functional keys for instructing a reception operation of a TV broadcasting signal and a reproduction operation of a reproduction medium. If a user manipulates a predetermined functional key disposed at the instruction input unit (110), the instruction input unit (110) creates an operation instruction related thereto and the created operation instruction is inputted to the controller (100).

Reference numeral 120 is a deck unit. The deck unit (120) is accommodated with a predetermined storage medium such as a videocassette tape or a DVD. The deck unit (120) reproduces an AV signal recorded in the accommodated storage medium in response to the control of the controller (100) and outputs a reproduction AV signal.

Reference numeral 130 is an amplifier for amplifying the reproduced AV signal outputted by the deck unit (120). Reference numeral 140 is a tuner unit for receiving a TV broadcasting signal of a predetermined channel via an antenna (150) in response to the control of the controller (100).

Reference numeral 160 is an AV signal processor. The AV signal processor (160) switches and selects the reproduction AV signal outputted from the amplifier (130) in response to the control of the controller (100) and the broadcasting AV signal outputted from the tuner unit (140). The AV signal processor (160) processes and outputs the selected AV signal, allows an image to be displayed on a display panel, and an audio signal to be outputted via a speaker.

The multifunction device thus constructed according to the prior art is such that if a user instructs a viewing of a TV broadcasting signal via the instruction input unit (110), the controller (100) controls the tuner unit (140) and simultaneously notifies the AV signal processor (160) of the viewing of the TV broadcasting signal. The tuner unit (140) receives a TV broadcasting signal of a predetermined channel out of a plurality of TV broadcasting signals received via the antenna (150) in response to the control of the controller (100) and outputs the broadcasting AV signal. The AV signal outputted by the tuner unit (140) is switched and selected by the AV signal processor (160), processed and outputted so that a viewer can view the TV broadcasting signal of a predetermined channel.

If a user accommodates a storage medium such as a tape cassette or an optical disc into the deck unit (120), the deck unit (120) detects the accommodation of the storage medium and notifies it to the controller (100). If the deck unit (120) is accommodated with a storage medium, a user manipulates the instruction input unit (110) and instructs the controller (100) to reproduce a predetermined storage medium.

Then, the controller (100) controls the deck unit (120) and prompts the deck unit (120) to implement a reproduction operation of the predetermined storage medium. The controller (100) also notifies the AV signal processor (160) of the reproduction of the predetermined storage medium.

The deck unit (120) implements a reproduction operation of the predetermined storage medium to output a reproduction AV signal. The reproduced AV signal thus outputted is amplified by the amplifier (130) and switched, selected and processed by the AV signal processor (160) and outputted to a display panel and a speaker so that a user can view the AV signal reproduced by the predetermined storage medium.

However, there is a problem in the prior art thus described in that because a singular controller (100) is configured to control all the operations of the AV reproduction apparatus and the TV set, the controller (100) is overloaded with the operations, resulting in a glitch of operation control of the AV reproduction apparatus and the TV set.

There is another problem in that because the AV signal processor (160) directly switches and selects the broadcasting AV signal and the reproduction AV signal, interference occurs between an AV signal selected right before the switching process of the AV signal and the currently selected AV signal, resulting in a static. The static thus generated is outputted via a screen of a display panel and a speaker, causing an unpleasant feeling to a user.

There is still another problem in that when switching is effected from a broadcasting AV signal to a reproduction AV signal, the AV signal processor (160) selects the reproduction AV signal to cause a screen and a speaker to produce no signal even though no reproduction AV signal has been outputted from the deck unit (120). For example, assuming that the deck unit (120) is accommodated with a tape cassette, it takes some time for the deck unit (120) to extract videotape from the tape cassette in response to the control of the controller (100), and to wind and reproduce the tape on a head drum. Even though the deck unit (120) is accommodated with an optical disc, it takes some time for the deck unit (120) to move an optical pickup to a predetermined track of the optical disc and to reproduce in response to the control of the controller (100). However, in the prior art, the AV signal processor (160) performs the switching according to the control of the controller (100) to select the reproduction AV signal, not waiting for the deck unit (120) to reproduce the storage medium and the reproduced AV signal to be outputted. As a result, there arises a problem in that no signal is generated on a screen and a speaker for a predetermined period of time from the reproduction of the storage medium by the deck unit (120) to the output of the reproduction AV signal.

### SUMMARY OF THE INVENTION

It is an object of the present invention to provide an AV signal switching apparatus and a method in a multifunction device configured to provide a mute time where neither the broadcasting AV signal nor the reproduction AV signal is selected when the broadcasting AV signal and the reproduction AV signal are switched and selected, preventing an occurrence of static in the outputted AV signals.

It is another object of the present invention to provide an AV signal switching apparatus and a method in a multifunction device configured to allow an AV signal to be continuously listened to during a predetermined period of time until a reproduced AV signal is outputted from a deck unit when the reproduced AV signal is selected from a broadcasting AV signal.

It is still another object of the present invention to provide an AV signal switching apparatus and a method in a multifunction device configured to have an AV reproduction device and a TV set each equipped with a controller so that the AV signal switching apparatus and a TV set can be smoothly operated.

In accordance with the object of the present invention, an AV signal switching apparatus in a multifunction device comprises: an AV signal switching apparatus for generating a control data corresponding to an operation instruction if the operation instruction is generated from a TV set and for a storing medium reproducing an AV signal if there is generated a reproduction instruction of the storing medium; an interface unit for transmitting the control data generated by the AV signal switching apparatus; and a TV set for receiving a predetermined channel of TV broadcasting signal in response to the control data transmitted by the interface unit and for switching and processing the received TV broadcasting signal or the AV signal reproduced by an AV reproduction device for a predetermined period of mute time.

The AV signal reproduction device further comprises: an instruction input unit for inputting an operation instruction in response to manipulation of a user; a deck unit for reproducing an AV signal at a storing medium; a Digital-to-Analogue (D/A) converter for converting the reproduction AV signal reproduced by the deck unit to an analogue signal and outputting the signal to the TV set; and a first controller for generating a corresponding control data if the operation instruction inputted by the instruction input unit is an instruction for controlling an operation of the TV set and transmitting the control data to the TV set via the interface unit and for controlling an operation of the deck unit if the operation instruction inputted by the instruction input unit is an operation instruction of the AV reproduction device.

The TV set further comprises: a second controller for controlling the entire operation of the TV set in response to the control data transmitted from the interface unit: a tuner unit for receiving a predetermined channel of TV broadcasting signal in response to the control of the second controller out of a plurality of TV broadcasting signals received via an antenna and outputting a broadcasting AV signal; and an AV signal processor for arranging a predetermined period of mute time in response to the control of the second controller and selectively switching and processing the broadcasting AV signal outputted by the tuner or the AV signal inputted from the AV reproduction device.

The interface unit further comprises: a first communication line drive for transmitting the control data outputted by the AV reproduction device to the TV set side and for receiving data transmitted from the TV set side and transmitting the data to the AV reproduction device; and a second communication line driver for transmitting data outputted by the TV set to the first communication line driver and for receiving data outputted by the first communication line driver and transmitting the data to the TV set.

In accordance with an aspect of the present invention, it is provided with an AV signal switching method in a multifunction device comprising the steps of; the first controller controlling the deck unit to implement a reproduction initial operation of a storing medium in the first controller of the AV reproduction device is generated with a reproduction instruction of the storing medium while the AV signal of the TV broadcasting signal received by the tuner unit of the TV set is processed by the AV signal processor; the first controller generating a control data notifying a reproduction start of the storing medium and transmitting the data to the second controller if the deck unit completes the reproduction initial operation of the storing medium and starts to reproduce the AV signal; the second controller controlling the AV signal processor in response to the transmitted control data to avoid selecting the AV signal during a preset mute time; and the AV signal processor selecting and processing the reproduction AV signal in response to the control of the second controller if the mute time has lapsed.

In accordance with another aspect of the present invention, it is provided with an AV signal switching method in a multifunction device comprising the steps of: the first controller controlling the deck unit to stop the reproduction operation of the storing medium and generating a control data notifying the watching of the TV broadcasting signal and transmitting the control data to the second controller if an instruction of watching the TV broadcasting signal is generated while the AV signal processor processes the AV signal reproduced by the deck unit via storing medium; the second controller controlling the AV signal processor in response to the transmitted control data to avoid selecting the AV signal; and the AV signal processor selecting and processing the AV signal of the TV broadcasting signal outputted from the tuner in response to the control of the second controller if the mute time has lapsed.

### BRIEF DESCRIPTION OF THE DRAWINGS

FIG. 1 is a block diagram illustrating a construction of a multifunction device according to the prior art.

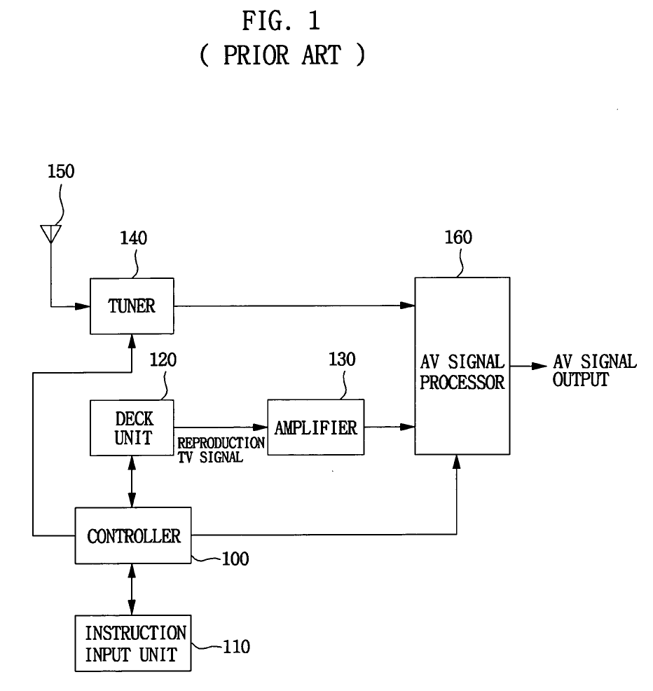

FIG. 2 is a block diagram illustrating an example of a construction of a multifunction device applied with a switching apparatus according to the present invention.

FIG. 3 is a signal flow chart illustrating an operation of switching and selecting a reproduction signal of the TV broadcasting signal in a switching method according to the present invention.

FIGS. 4a to 4c illustrate schematic drawings of an operation of FIG. 3.

FIG. 5 is a signal flow chart illustrating an operation switching and selecting a TV broadcasting signal in reproduction AV signal according to the switching method of the present invention.

FIGS. 6a to 6c illustrate schematic drawings of an operation of FIG. 5.

### DETAILED DESCRIPTION OF THE INVENTION

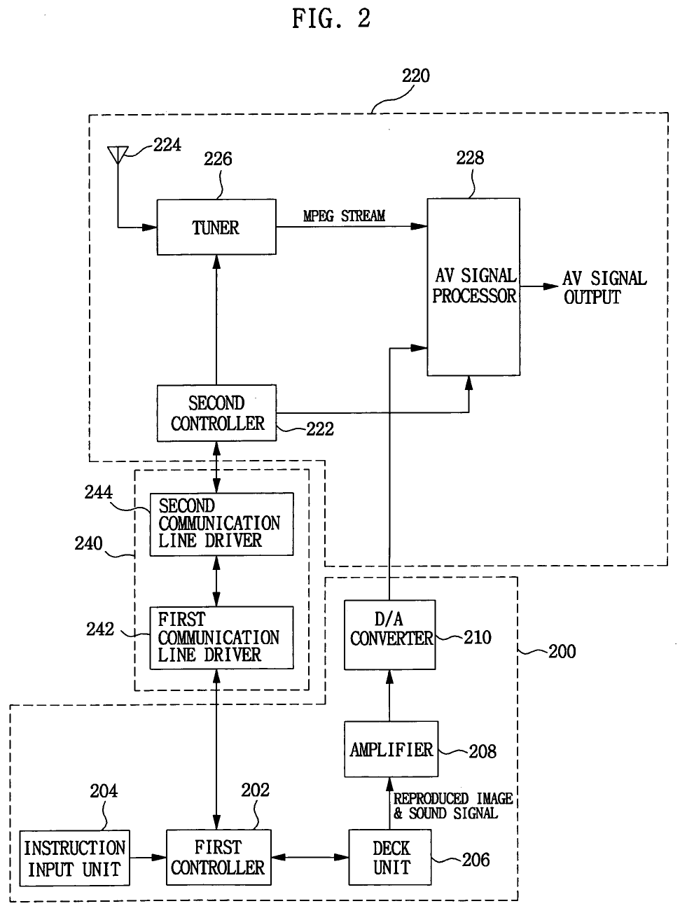

FIG. 2 is a block diagram illustrating an example of a construction of a multifunction device applied with a switching apparatus according to the present invention, where reference numeral 200 is an AV reproduction device, reference numeral 220 is a TV set and reference numeral 240 is an interface unit disposed between the AV reproduction device (200) and the TV set (240) and for interfacing a predetermined data transmitted therebetween.

The AV reproduction device (200) includes a first controller (202), an instruction input unit (204), a deck unit (206), an amplifier (208) and an Analogue-to-Digital (A/D) converter (210).

The first controller (202) controls an operation of reproducing a predetermined storing medium. The first controller (202) also generates a control data for controlling an operation of the TV set (220) in response to the instruction of a user.

The instruction input unit (204) is disposed with a plurality of functional keys for instructing operations of the AV reproduction device (200) and the TV set (220). If the user instructs a predetermined functional key disposed at the instruction input unit (204), the instruction input unit (204) generates a relevant operational instruction and the generated operation instruction is inputted into the first controller (102).

The deck unit (206) is accommodated with a storing medium such as videocassette tape or DVD. The deck unit (206) also reproduces the accommodated storing medium in response to the control of the first controller (202) to output a reproduced AV signal.

The amplifier (208) serves to amplify the reproduced AV signal outputted from the deck unit (208).

The A/D converter (210) converts the reproduced AV signal amplified by the amplifier (208) to a digital signal and outputs the digital signal to the TV set (220). The TV set (220) is disposed with a second controller (222), an antenna (224), a tuner (226) and an AV signal processor (228).

The second controller (222) controls the entire operation of the TV set in response to the control data transmitted via the interface unit (240) from the first controller (202) of the AV reproduction device (200). The second controller (222) also controls reception f a predetermined channel of TV broadcasting signal in response to the control data. The second controller (222) further controls the switching operation of the AV signal of the received TV broadcasting signal and the AV signal reproduced by the AV reproduction device.

The tuner (226) receives a predetermined channel of TV broadcasting signal in response to the control of the second controller (222) out of TV broadcasting signals received via the antenna (224) to output a Moving Picture Expert Group (MPEG) streaming The AV signal processor (228) switches and selects the MPEG stream outputted by the tuner (226) and the AV signal reproduced by the AV reproduction device (200) from the storing medium in response to the control of the second controller (222). The AV signal processor (228) processes the selected signal and outputs the selected signal to display panel and speaker sides such that a user can watch the AV signal.

The interface unit (240) includes a first communication line driver (242) and a second communication line driver (244).

The first communication line driver (242) transmits to the second controller (222) of the TV set via the second communication line driver a predetermined control data outputted by the first controller (202) of the AV reproduction device (200). The first communication line driver (242) also transmits to the first controller (202) of the AV reproduction device (200) a predetermined data inputted via the second communication line driver (244) from the second controller (222) of the TV set (220).

The second communication line driver (244) transmits to the second controller (222) a predetermined data inputted via the first communication line driver (242) from the first controller (202) of the AV reproduction device (200). The second controller (222) receives a predetermined data outputted by the second controller (222) of the TV set (220) and transmits the data to the first controller (202) of the AV reproduction device (200) via the first communication line driver (242).

In the present invention thus constructed, if a user instructs a command to watch a TV broadcasting signal via the instruction input unit (204), the first controller (202) generates a control data notifying the watch of the TV broadcasting signal. The generated control data is transmitted to the second controller (222) of the TV set (220) sequentially through the first communication line driver (242) and the second communication line driver (244) of the interface unit (240).

The second controller (222) discriminates the watching of the TV broadcasting signal by the control data transmitted from the first controller (202), and controls the tuner (226) to receive a predetermined channel of TV broadcasting signal. The second controller (222) also controls the AV signal processor (228) to notify that the TV broadcasting signal is being watched.

Successively, the tuner (226) receives a predetermined channel of TV broadcasting signal out of broadcasting signals received via the antenna (224) to output a MPEG stream. The MPEG stream outputted by the tuner (226) is selectively switched, processed and outputted by the AV signal processor (228).

If a user accommodates a storing medium to the deck unit (206) while a predetermined channel of TV broadcasting signal is being watched, the deck unit (206) detects the accommodation of the storing medium and notifies it to the first controller (202). Then, the first controller (202) discriminates that a reproduction instruction of the storing medium is generated. If the storing medium is already accommodated in the deck unit (206), a user can manipulates the instruction input unit (204) and instructs the first controller (202) to reproduce the storing medium.

If the reproduction instruction of the storing medium is created, the first controller (202) generates a control data notifying that the storing medium is to be reproduced. The generated control data is transmitted to the second controller (222) via the first communication line driver (242) and the second communication line driver (244) of the interface unit (240).

Furthermore, the first controller (202) controls the deck unit (206) to execute a reproduction initial operation of the storing medium. In other words, if the storing medium is a videocassette tape, the deck unit (206) takes out the videotape from a tape cassette in response to the control of the first controller (202) and winds it around a head drum. If the storing medium is an optical disc, the deck unit (206) moves an optical pickup to a predetermined track of the optical disc in response to the control of the first controller (202) and seeks an initial location of the AV signal stored in the optical disc.

At this time, the second controller (222) checks only that the deck unit (206) starts to reproduce the storing medium by the data transmitted by the first controller (202) and waits for a time consumed until a predetermined reproduction AV signal is outputted from the deck unit (206). The AV signal processor (228) continuously processes the AV signal of the TV broadcasting signal.

If the deck unit (206) completes the initial operation and the storing medium starts to reproduce a predetermined AV signal under the above-mentioned circumstance, the AV signal reproduced by the deck unit (206) is amplified by the amplifier (208), and is converted to a digital signal by the A/D converter (210) to be inputted to the AV signal processor (228) of the TV set (220).

The first controller (202) verifies that the deck unit (206) has started to reproduce a predetermined AV signal from the storing medium and transmits a control data notifying to the second controller (222) via the first and second communication line drivers (242. 244) of the interface unit (240) that reproduction of the storing medium has started.

The second controller (222) discriminates via the transmitted control data that the deck unit (206) has started to reproduce a predetermined AV signal from the storing medium, and controls in such a manner that the AV signal processor (206) does not select any signal during a predetermined mute time, thereby enabling to avoid creating static when the AV signal is switched. In other words, the AV signal processor (228) selects neither the MPEG stream inputted from the tuner (226) nor the AV signal inputted from the D/A converter (210) during the predetermined mute time.

If the predetermined mute time has lapsed, the AV signal processor (228) selects and processes the reproduced AV signal outputted from the A/D converter (210), and outputs the reproduced AV signal to a display panel and a speaker. A user now can watch the predetermined AV signal reproduced by the predetermined storing medium.

If the user manipulates the instruction input unit (204) and instructs the first controller (202) to watch the TV broadcasting signal, while the reproduced AV signal reproduced by the predetermined storing medium is being watched, the first controller (202) controls the deck unit (206) and stops the reproduction operation of the storing medium.

Furthermore, the first controller (202) transmits a control data to the second controller (222) via the first and second communication line drivers (242. 244) of the interface unit (240) notifying that the TV broadcasting signal is being watched.

The second controller (222) then discriminates through the transmitted data that the TV broadcasting signal is being watched, and controls the AV signal processor (228) in such a manner that the AV signal processor (228) does not select any signal during the predetermined mute time. If the predetermined mute time lapses, the AV signal processor (228) selectively switches and processes the MPEG stream outputted by the tuner (226) which has received a predetermined TV broadcasting signal, and outputs the MPEG stream to a display panel and a speaker.

As described in the foregoing of the present invention, the first controller (202) and the second controller (222) are respectively mounted at the AV reproduction device (200) and the TV set (220), and operations are controlled thereby. Therefore, there is generated no overload at the first and second controllers (202. 222) and operation of the AV reproduction device (200) and the TV set (220) is smoothly controlled.

Furthermore, if the AV signal processor (228) selectively switches the MPEG stream outputted by the tuner (226) and the reproduction AV signal outputted by the AV reproduction device (200), a mute time of avoiding selecting both the MPEG stream and the AV reproduction signal is available, such that there is generated no interference in between the MPEG stream and the AV reproduction signal, enabling to watch a clean AV signal.

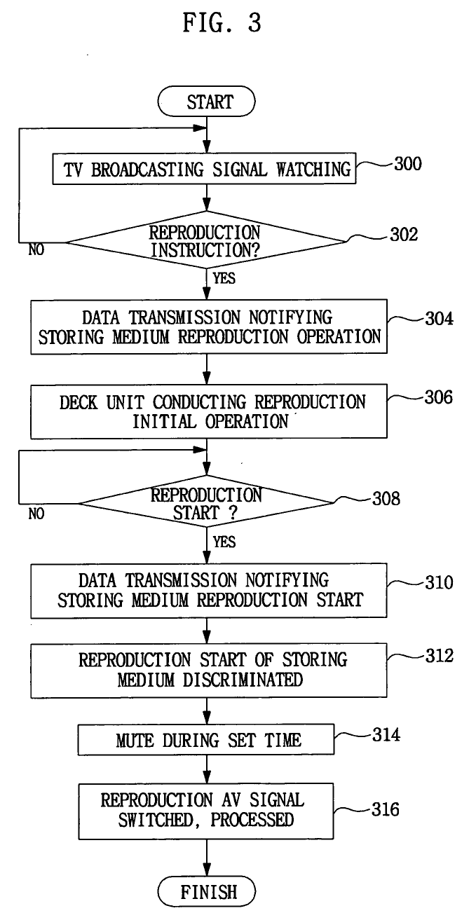

Meanwhile, FIG. 3 is a signal flow chart illustrating an operation of switching and selecting a reproduction signal of the TV broadcasting signal in a switching method according to the present invention, where S denotes a step.

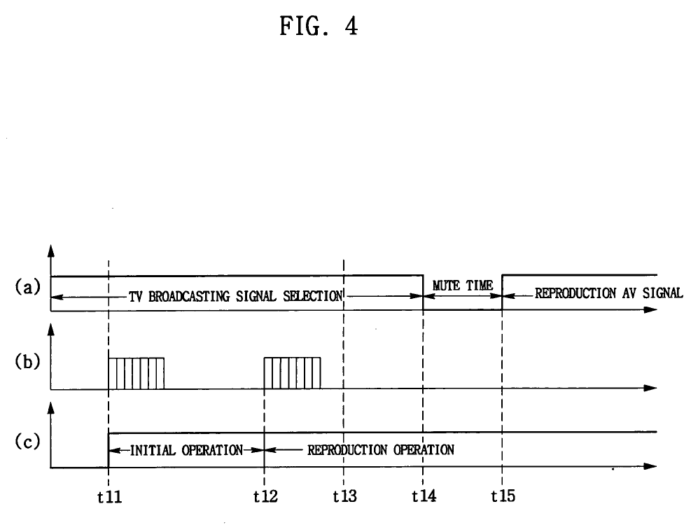

First of all, a predetermined channel of TV broadcasting signal is watched (S300). In other words, the tuner (226) receives a predetermined channel of TV broadcasting signal in response to the control of the second controller (222) to output a MPEG stream, and the MPEG stream is selected and processed by the AV signal processor (228) as shown in FIG. 4a such that a user can view the predetermined channel of TV broadcasting signal.

Under this circumstance, the first controller (202) discriminates whether a reproduction instruction of a predetermined storing medium has been generated (S302). In other words, the first controller (202) discriminates whether the deck unit (206) is accommodated with a predetermined storing medium or a reproduction instruction of storing medium is inputted from the instruction input unit (204)

As a result of discrimination, if the reproduction instruction of the storing medium is generated at a time (t11), the first controller (202) transmits to the second controller (222) a data notifying the reproduction operation of the storing medium via the first and second communication line drivers (242. 244) (S304), as shown in FIG. 4b. Successively, the second controller (202) controls the deck unit (206) and carries out a reproduction initial operation of the storing medium (S305), as illustrated in FIG. 4c.

Under the circumstance thus described, the deck unit (206) completes the reproduction initial operation of the storing medium at a time (t12) and starts to reproduce the AV signal recorded in the storing medium as shown in FIG. 4c. Thereafter, the first controller (202) discriminates that the deck unit (206) starts to reproduce the AV signal (S308) and transmits a control data to the second controller (222) via the first and second communication line drivers (242. 244) of the interface unit (240) notifying that reproduction of the storing medium has started (S310) as depicted in FIG. 4b.

The second controller (222) discriminates via the transmitted control data that reproduction of the AV signal recorded in the storing medium has started at a time (t13) (S312). Furthermore, the second controller (222) controls the AV signal processor (160) to avoid selecting neither the MPEG stream outputted from the tuner (226) nor the reproduction AV signal outputted from the A/D converter (210) during a predetermined period of time (t14˜t15) as shown in FIG. 4a (S314).

Under this circumstance, if the predetermined mute time (t14˜t15) lapses, the second controller (222) controls the AV signal processor (228), and selects, processes and outputs the reproduction AV signal outputted from the A/D converter (210) as illustrated in FIG. 4a (S316). Henceforth, the user can view the AV signal reproduced by the storing medium.

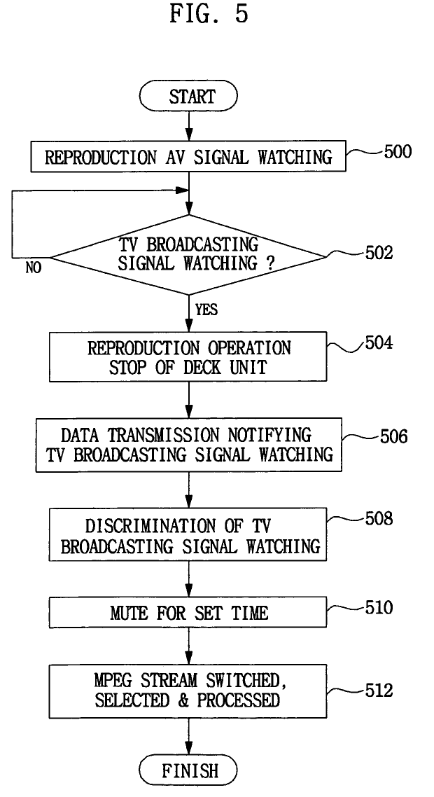

FIG. 5 is a signal flow chart illustrating an operation switching and selecting a TV broadcasting signal in reproduction AV signal according to the switching method of the present invention.

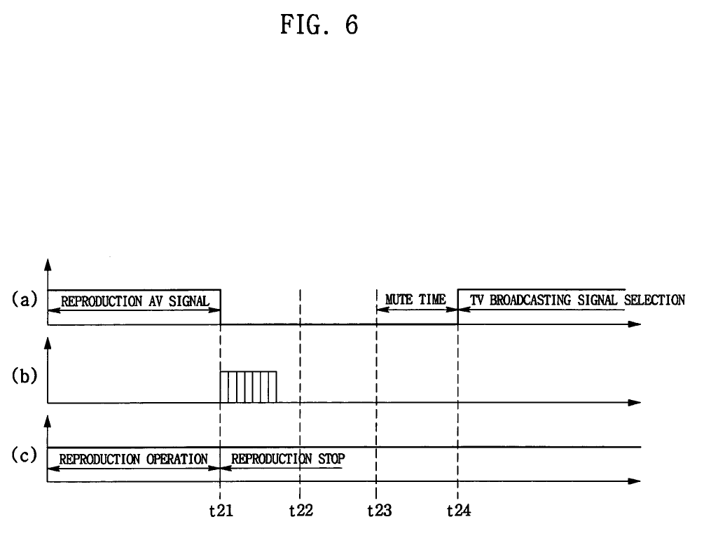

Referring to FIG. 6a, first of all, the AV signal processor (228) selects and processes the reproduced AV signal outputted from the A/D converter (210) in response to the control of the second controller (222) (S500) such that a user can view the reproduction AV signal.

Under this circumstance, the first controller (202) discriminates whether there is generated a viewing instruction of the TV broadcasting signal (S502). For example, the first controller (202) discriminates whether the deck unit (206) has completed the reproduction operation of a predetermined storing medium or a start instruction of the TV broadcasting signal is inputted from the instruction input unit (204).

If it is discriminated as a result of the discrimination that the viewing instruction of the TV broadcasting signal has been generated, the first controller (202) stops the reproduction operation of the deck unit (206) at a time (t16) as illustrated in FIG. 6c (S504). Now, referring to FIG. 6b, the first controller (202) transmits a control data to the second controller (222) via the first and second communication line drivers (242. 244) of the interface unit (240) notifying that reproduction of the storing medium has started (S506).

Successively, the second controller (222) discriminates through the transmitted data tat the TV broadcasting signal is being watched (S508). If it is discriminated that the watching of the TV broadcasting signal is being implemented, the second controller (222) controls the AV signal processor (160) to avoid selecting neither the MPEG stream outputted from the tuner (226) nor the reproduction AV signal outputted from the A/D converter (210) during a predetermined period of time (t23˜t24) as shown in FIG. 6a (S510).

Under this circumstance, if the predetermined mute time (t23˜t24) lapses, the second controller (222) controls the AV signal processor (228), and selects the TV broadcasting signal as shown in FIG. 6a, and processes and outputs the reproduction AV signal (S512). In other words, the AV signal processor (228) selects, processes and outputs the MPEG stream outputted by reception of a predetermined channel of TV broadcasting signal by the tuner (226) such that a user can view the predetermined channel of TV broadcasting signal

As apparent from the foregoing, the present invention equipped at a TV set and an AV reproduction device each with a controller controls the operation such that the controller is not overloaded to enable to smoothly control the operation of the TV set and the AV reproduction device.

Furthermore, a predetermined period of mute time is given for switching a broadcasting AV signal and a reproduction AV signal, whereby there is generated no interference between the broadcasting AV signal and the reproduction AV signal to enable to obtain a natural image processing effect and a clean AV signal for a user.

Still furthermore, a deck unit can reproduce a storing medium to enable to select and output a continuous broadcasting AV signal during a predetermined period of time up to the reproduction signal being outputted if the reproduction AV signal is switched and viewed and when the broadcasting AV signal is watched. Therefore, a time in which the AV signal is not outputted to a display panel and a speaker can be minimized.

The present invention may be embodied in other specific forms without departing from its spirit or essential characteristics. The described embodiments are to be considered in all respects only as illustrative and not restrictive. Those skilled in the art will appreciate that the present invention has been described in terms of exemplary embodiments and various changes and modifications are possible.

In other words, although the above-mentioned exemplary embodiments have described that a TV set receives a digital TV broadcasting signal, the present invention is not limited thereto, and the present invention can be simply applied to various devices for switching and selecting an AV signal such as a multifunction device integrally equipped with an analogue TV set for receiving an analogue TV broadcasting signal and an AV reproduction device and the like.

What is claimed is:

1. An AV signal switching apparatus in a multifunction device comprising:
an AV signal switching apparatus for generating a control data corresponding to an operation instruction if the operation instruction is generated from a TV set and for a storing medium reproducing an AV signal if there is generated a reproduction instruction of the storing medium;
an interface unit for transmitting the control data generated by the AV signal switching apparatus; and
a TV set for receiving a predetermined channel of TV broadcasting signal in response to the control data transmitted by the interface unit and for switching and processing the received TV broadcasting signal or the AV signal reproduced by an AV reproduction device for a predetermined period of mute time.

2. The apparatus as defined in claim 1, wherein the AV signal reproduction device further comprises:
an instruction input unit for inputting an operation instruction in response to manipulation of a user;
a deck unit for reproducing an AV signal at a storing medium;
a Digital-to-Analogue (D/A) converter for converting the reproduction AV signal reproduced by the deck unit to an analogue signal and outputting the signal to the TV set; and
a first controller for generating a corresponding control data if the operation instruction inputted by the instruction input unit is an instruction for controlling an operation of the TV set and transmitting the control data to the TV set via the interface unit and for controlling an operation of the deck unit if the operation instruction inputted by the instruction input unit is an operation instruction of the AV reproduction device.

3. The apparatus as defined in claim 2 further comprising an amplifier between the deck unit and the D/A converter.

4. The apparatus as defined in claim 1, wherein the TV set further comprises:
a second controller for controlling the entire operation of the TV set in response to the control data transmitted from the interface unit;
a tuner unit for receiving a predetermined channel of TV broadcasting signal in response to the control of the second controller out of a plurality of TV broadcasting signals received via an antenna and outputting a broadcasting AV signal; and
an AV signal processor for arranging a predetermined period of mute time in response to the control of the second controller and selectively switching and processing the broadcasting AV signal outputted by the tuner or the AV signal inputted from the AV reproduction device.

5. The apparatus as defined in claim 4, wherein the broadcasting AV signal is a MPEG stream.

6. The apparatus as defined in claim 1, wherein the interface unit further comprises:
a first communication line drive for transmitting the control data outputted by the AV reproduction device to the TV set side and for receiving data transmitted from the TV set side and transmitting the data to the AV reproduction device; and
a second communication line driver for transmitting data outputted by the TV set to the first communication line driver and for receiving data outputted by the first communication line driver and transmitting the data to the TV set.

7. An AV signal switching method in a multifunction device comprising the steps of:
a first controller controlling a deck unit to stop the reproduction operation of a storing medium and generating a control data notifying the watching of a TV broadcasting signal and transmitting the control data to a second controller if an instruction of watching the TV broadcasting signal is generated while an AV signal processor processes the AV signal reproduced by the deck unit via storing medium;
a second controller controlling the AV signal processor in response to the transmitted control data to avoid selecting the AV signal; and
the AV signal processor selecting and processing the AV signal of the TV broadcasting signal outputted from the tuner in response to the control of the second controller if the mute time has lapsed.

8. The method as defined in claim 7, wherein the broadcasting AV signal is a MPEG stream.

9. The method as defined in claim 7, wherein the reproduction instruction of the storing medium is generated when the deck unit is accommodated in the storing medium or the reproduction instruction of the storing medium is inputted from the instruction input unit.

10. The method as defined in claim 7 further comprising a step of the first controller generating a control data notifying the generation of the storing medium and transmitting the control data to the second controller.

11. The method as defined in claim 7, wherein the AV signal processor selects and processes the AV signal of the TV broadcasting signal before the mute time.

12. An AV signal switching method in a multifunction device comprising the steps of:
a first controller controlling a deck unit to stop a reproduction operation of a storing medium and generating a control data notifying the watch of TV broadcasting signal and transmitting the control data to a second controller if there is generated a watching instruction of the TV broadcasting signal in a state where an AV signal processor processes an AV signal reproduced from the storing medium by the deck unit;
a second controller controlling the AV signal processor to avoid selecting the AV signal in response to the transmitted control data; and
the AV signal processor selecting and processing the AV signal of the TV broadcasting signal outputted by a tuner in response to the control of the second controller if the mute time lapses.

13. The method as defined in claim 12, wherein the watching instruction generation of the TV broadcasting signal is created when the deck unit completes the reproduction of the AV signal at the storing medium or a watching instruction of the TV broadcasting signal is inputted from an instruction input unit.

14. The method as defined in claim 12, wherein the AV signal of the TV broadcasting signal is MPEG stream.
